(19) United States
(12) Patent Application Publication
(10) Pub. No.: US 2013/0156535 A1
(43) Pub. Date: Jun. 20, 2013

(54) LINEAR MOTION MECHANISM AND ROBOT PROVIDED WITH THE LINEAR MOTION MECHANISM

(71) Applicant: KABUSHIKI KAISHA YASKAWA DENKI, Fukuoka (JP)

(72) Inventors: Tadataka NOGUCHI, Fukuoka (JP); Kensuke OHNI, Fukuoka (JP)

(73) Assignee: KABUSHIKI KAISHA YASKAWA DENKI, Fukuoka (JP)

(21) Appl. No.: 13/670,555

(22) Filed: Nov. 7, 2012

(30) Foreign Application Priority Data
Dec. 20, 2011 (JP) 2011-278839

(51) Int. Cl. B25J 18/04

(52) U.S. Cl. CPC B25J 18/04; Y10S 901/15
USPC 414/744.5; 901/15

(57) ABSTRACT

A linear motion mechanism includes a base portion; a guide member attached to the base portion; and a slider provided to slide along an axial direction of the guide member. The guide member is fastened to the base portion by a guide fastening member in a specified fastening direction substantially orthogonal to the axial direction, and is pressed by a guide pressing member in an orthogonal direction substantially orthogonal to both the axial direction and the fastening direction.

### BACKGROUND OF THE INVENTION

1. Field of the Invention

Embodiments disclosed herein relate to a linear motion mechanism and a robot provided with the linear motion mechanism.

2. Description of the Related Art

Conventionally, there is known a robot for holding and transferring a substrate such as a glass substrate for use in a liquid crystal display through the use of a hand provided in an end operating unit of an arm. The robot is often a so-called multiple axes robot in which the arm and the hand are moved along a linear motion shaft or about a rotation shaft.

For example, Japanese Patent Application Publication No. JP11-77566 discloses a substrate transfer robot including a first arm rotatably supported with respect to a linear motion shaft of a vertically movable base, a second arm rotatably supported with respect to the first arm and a hand rotatably attached with respect to the second arm.

It is typical that a guide member such as a rail or the like is used as the linear motion shaft. In the following description, for the sake of convenience in description, the linear motion shaft will be sometimes referred to as “rail”.

In recent years, the size of a liquid crystal display tends to grow larger and the weight of a substrate becomes heavier. Thus the load applied to a linear motion mechanism including a rail used in the robot gets increased and the rail may be out of alignment. This poses a problem in that it is sometimes impossible to obtain desired operation accuracy.

### SUMMARY OF THE INVENTION

In accordance with one aspect of the present invention, there is provided a linear motion mechanism, including: a base portion; a guide member attached to the base portion; and a slider provided to slide along an axial direction of the guide member, wherein the guide member is fastened to the base portion by a guide fastening member in a specified fastening direction substantially orthogonal to the axial direction, and is pressed by a guide pressing member in an orthogonal direction substantially orthogonal to both the axial direction and the fastening direction.

### BRIEF DESCRIPTION OF THE DRAWINGS

FIG. 1 is a schematic perspective view showing a robot according to a first embodiment.

FIG. 2 is a schematic side view showing the robot installed within a vacuum chamber.

FIG. 3A is a schematic plan view showing a body unit.

FIG. 3B is a section view taken along line 3B-3B in FIG. 3A.

FIG. 4A is a section view taken along line 4A-4A in FIG. 3B.

FIG. 4B is an enlarged view showing a conventional sliding contact unit.

FIG. 4C is an enlarged view of the region designated by G2 in FIG. 4B.

FIG. 4D is an enlarged view showing a sliding contact unit according to a first embodiment.

FIG. 5 is a schematic diagram showing major parts of a linear motion mechanism according to a second embodiment.

FIG. 6 is an explanatory view showing a linear motion mechanism according to a third embodiment.

### DESCRIPTION OF THE EMBODIMENTS

Embodiments of a linear motion mechanism and a robot provided with the linear motion mechanism will now be described with reference to the accompanying drawings which form a part hereof. The present disclosure is not limited to the embodiments to be described below.

In the following description, a thin flat substrate such as a glass substrate or the like will be referred to as “workpiece”. Description will be made by taking, as an example, a robot for transferring a workpiece within a vacuum chamber.

### First Embodiment

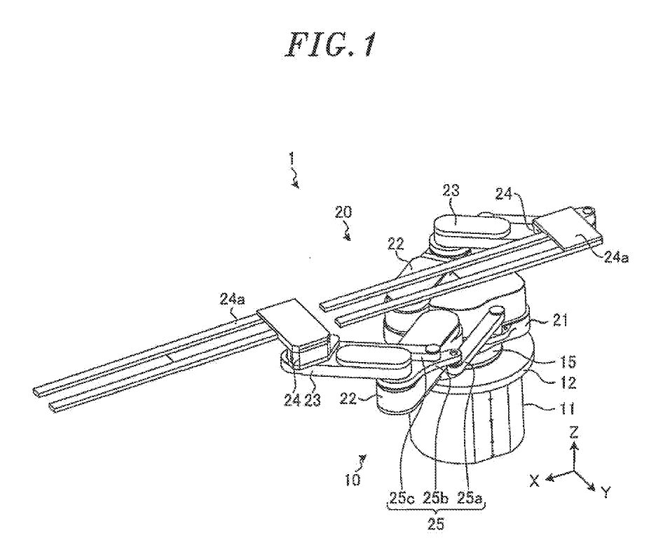

First, the configuration of a robot according to a first embodiment will be described with respect to FIG. 1. FIG. 1 is a schematic perspective view showing the robot 1 according to the first embodiment.

For the sake of easier understanding of the description, a three-dimensional rectangular coordinate system, including a Z-axis whose vertical upper side is the positive side and whose vertical lower side is the negative side, is indicated in FIG. 1. The direction extending along an XY plane denotes a horizontal direction. It is sometimes the case that the aforementioned rectangular coordinate system is indicated in other figures used in the following description.

In the following description, it is sometimes the case that only one of a plurality of components is designated by a reference symbol with the remaining components not given any reference symbol. In that case, one component designated by a reference symbol has the same configuration as the remaining components.

As shown in FIG. 1, the robot 1 is a multiple axes robot including two extendible arm units that can extend and retract in a horizontal direction. More specifically, the robot 1 includes a body unit 10 and an arm unit 20.

The body unit 10 is a unit provided below the arm unit 20. The body unit 10 includes a tubular housing 11 and a linear motion mechanism arranged within the housing 11. The body unit 10 moves the arm unit 20 up and down using the linear motion mechanism.

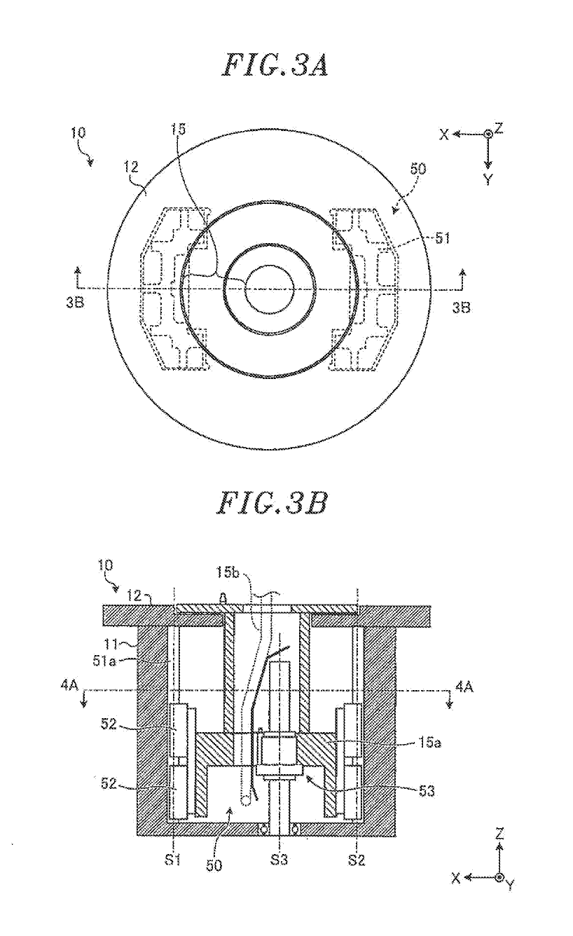

More specifically, the linear motion mechanism linearly moves a lift flange unit 15 of the body unit 10 along a vertical direction, thereby lifting and lowering the arm unit 20 fixed to the lift flange unit 15. Details of the linear motion mechanism will be described later with respect to FIG. 3A.

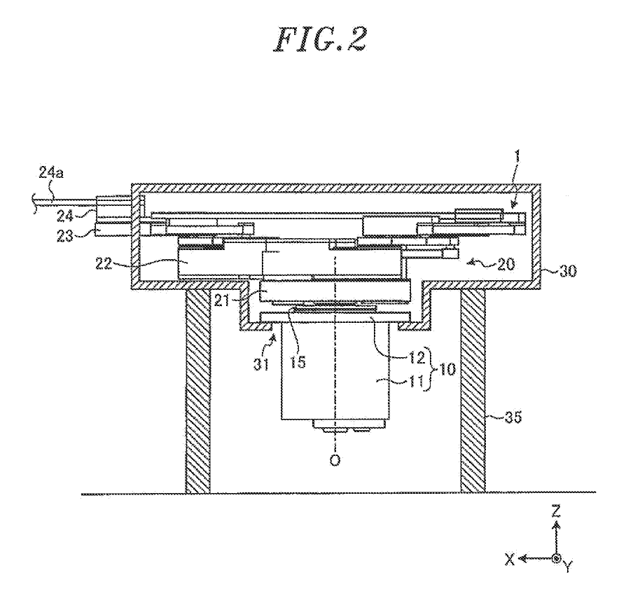

A flange portion 12 is formed in the upper portion of the housing 11. The robot 1 is installed in a vacuum chamber by fixing the flange portion 12 to the vacuum chamber. On this point, description will be made later with reference so FIG. 2.

The arm unit 20 is a unit connected to the body unit 10 through the lift flange unit 15. More specifically, the arm unit 20 includes an arm base 21, a first arm 22, a second arm 23, a hand base 24 and an auxiliary arm 25.

The arm base 21 is rotatably supported with respect to the lift flange unit 15. The arm base 21 includes a swing mechanism made up of a motor and a speed reducer. The arm base 21 is swung by the swing mechanism.

More specifically, the swing mechanism is configured such that the rotation of a motor inputted via a transmission belt to a speed reducer whose output shaft is fixed to the body unit 10. Thus the arm base 21 horizontally revolves about the output shaft of the speed reducer as a swing axis.

The arm base 21 includes a box-shaped storage compartment kept at the atmospheric pressure. The motor, the speed reducer and the transmission belt are stored within the storage compartment. Therefore, even if the transfer robot 1 is used within a vacuum chamber as described later, it is possible to prevent a lubricant such as grease or the like from getting dry and to prevent the inside of the vacuum chamber from being contaminated by dirt.

The base end portion of the first arm 22 is rotatably connected to the upper portion of the arm base 21 through a first speed reducer not shown in the drawings. The base end portion of the second arm 23 is rotatably connected to the tip end upper portion of the first arm 22 through a second speed reducer not shown in the drawings.

The hand base 24 is rotatably connected to the tip end portion of the second arm 23. The hand base 24 is provided at an upper end thereof with an end effector 24a (i.e., a so-called hand) for holding a workpiece. The hand base 24 linearly moves in response to the rotating motion of the first arm 22 and the second arm 23.

The linear movement of the end effector 24a is caused by the first arm 22 and the second arm 23 being synchronously operated by the robot 1.

More specifically, the robot 1 rotates the first speed reducer and the second speed reducer through the use of a single motor, thereby synchronously operating the first arm 22 and the second arm 23. At This time, the robot 1 rotates the first arm 22 and the second arm 23 such that the rotation amount of the second arm 23 with respect to the first arm 22 becomes twice as large as the rotation amount of the first arm 22 with respect to the arm base 21.

For example, the robot 1 rotates the first arm 22 and the second arm 23 in such a way that, if the first arm 22 rotates a degree with respect to the arm base 21, the second arm 23 rotates 2α degrees with respect to the first arm 22. As a consequence, the robot 1 can linearly move the end effector 24a.

With a view to prevent contamination of the inside of the vacuum chamber, drive devices such as the first speed reducer, the second speed reducer, the motor and the transmission belt are arranged within the first arm 22 kept at the atmospheric pressure.

The auxiliary arm 25 a link mechanism that restrains rotation of the hand base 24 in conjunction with the rotating motion of the first arm 22 and the second arm 23 so that the end effector 24a can always face a specified direction during its movement.

More specifically, the auxiliary arm 25 includes a first link 25a, an intermediate link 25b and a second link 25c.

The base end portion of the first link 25a is rotatably connected to the arm base 21. The tip end portion of the first link 25a is rotatably connected to the tip end portion of the intermediate link 25b. The base end portion of the intermediate link 25b is pivoted in a coaxial relationship with a connecting axis that interconnects the first arm 22 and the second arm 23. The tip end portion of the intermediate link 25b is rotatably connected to the tip end portion of the first link 25a.

The base end portion of the second link 25c is rotatably connected to the intermediate link 25b. The tip end portion of the second link 25c is rotatably connected to the base end portion of the hand base 24. The tip end portion of the hand base 24 is rotatably connected to the tip end portion of the second arm 23. The base end portion of the hand base 24 is rotatably connected to the second link 25c.

The first link 25a, the arm base 21, the first arm 22 and the intermediate link 25b make up a first parallel link mechanism. In other words, if the first arm 22 rotates about the base end portion thereof, the first link 25a rotates while keeping parallelism with the first arm 22. When seen in a plan view, the intermediate link 25b rotates while keeping parallelism with an imaginary connecting line that interconnects the connecting axis of the arm base 21 and the first arm 22 and the connecting axis of the arm base 21 and the first link 25a.

The second link 25c, the second arm 23, the hand base 24 and the intermediate link 25b make up a second parallel link mechanism. In other words, if the second arm 23 rotates about the base end portion thereof, the second link 25c and the hand base 24 rotate while keeping parallelism with the second arm 23 and the intermediate link 25b, respectively.

The intermediate link 25b rotates while keeping parallelism with the aforementioned connecting line under the action of the first parallel link mechanism. For that reason, the hand base 24 of the second parallel link mechanism rotates while keeping parallelism with the aforementioned connecting line. As a result, the end effector 24a mounted to the upper portion of the hand base 24 moves linearly while keeping parallelism with the arm base 21.

In this manner, the robot 1 can maintain the orientation of the end effector 24a constant using two parallel link mechanisms, i.e., the first parallel link mechanism and the second parallel link mechanism. Therefore, as compared with a case where pulleys and transmission belts are provided within the second arm 23 to maintain constant the orientation of an end effector using the pulleys and the transmission belts, it is possible to reduce generation of dirt attributable to the pulleys and the transmission belts.

Since the rigidity of the arm unit as a whole can be increased by the auxiliary arm 25, it is possible to reduce the vibration generated during the operation of the end effector 24a. For that reason, it is possible to reduce generation of dirt attributable to the vibration generated during the operation of the end effector 24a.

As shown in FIG. 1, the robot 1 is a so-called dual arm robot that includes two extendible arm units, each of which includes the first arm 22, the second arm 23, the hand base 24, and the auxiliary arm 25. Therefore, the robot 1 can simultaneously perform two tasks, e.g., a task of taking out a workpiece from a specified transfer position using one of the extendible arm units and a task of carrying a new workpiece into the transfer position using the other extendible arm unit.

Next, the robot 1 installed within the vacuum chamber will be described with reference to FIG. 2. FIG. 2 is a schematic side view showing the robot 1 installed within the vacuum chamber.

As shown in FIG. 2, the flange portion 12 formed in the body unit 10 of the robot 1 is fixed through a seal member to the peripheral edge of an opening portion 31 formed in the bottom of the vacuum chamber 30. Thus the vacuum chamber 30 is hermetically sealed and the inside of the vacuum chamber 30 is kept in a depressurized state by a depressurizing device such as a vacuum pump or the like. The housing 11 of the body unit 10 protrudes from the bottom of the vacuum chamber 30 and lies within a space defined by a support portion 35 for supporting the vacuum chamber 30.

The robot 1 performs a workpiece transferring task within the vacuum chamber 30. For example, the robot 1 linearly moves the end effector 24a through the use of the first arm 22 and the second arm 23, thereby taking out a workpiece from another vacuum chamber connected to the vacuum chamber 30 through a gate valve not shown.

Subsequently, the robot 1 returns the end effector 24a back and then horizontally rotates the arm base 21 about a swing axis O, thereby causing the arm unit 20 to directly face another vacuum chamber as the transfer destination of the workpiece. Then, the robot 1 linearly moves the end effector 24a through the use of the first arm 22 and the second arm 23, thereby carrying the workpiece into another vacuum chamber as the transfer destination of the workpiece.

The vacuum chamber 30 is formed in conformity with the shape of the robot 1. For example, as shown in FIG. 2, a recess portion is formed in the bottom surface portion of the vacuum chamber 30. The portions of the robot 1 such as the arm base 21 and the lift flange unit 15 are arranged in the recess portion. By forming the vacuum chamber 30 in conformity with the shape of the robot 1 in this manner, it is possible to reduce the internal volume of the vacuum chamber 30 and to readily keep the vacuum chamber 30 in a depressurized state.

A space within which the arm unit 20 assuming a smallest swing posture can rotate and a space required for the arm unit 20 to be moved up and down by a lifting device are secured within the vacuum chamber 30. The smallest swing posture referred to herein means the posture of the robot 1 in which the rotation radius of the arm unit 20 about the swing axis O becomes smallest.

Next, details of the linear motion mechanism according to the first embodiment will be described with reference to FIG. 3A and the following figures. FIG. 3A is a schematic plan view showing a body unit. FIG. 3B is a section view taken along line 3B-3B in FIG. 3A.

Although partially overlapping with the description made in respect of FIGS. 1 and 2, the body unit 10 includes a flange portion 12 and a lift flange unit 15 as shown in FIG. 3A.

The body unit 10 is provided therein with linear motion mechanism 50 for moving the lift flange unit 15 up and down along the vertical direction. The linear motion mechanism 50 includes a pair of rail bases 51. The rail bases 51 are arranged on and fixed to the inner circumferential surface of the housing 11 (see FIG. 3B) so as to face each other. That is to say, the inner circumferential surface of the housing 11 constitutes a base portion of the linear motion mechanism 50.

As shown in FIG. 3B, the linear motion mechanism 50 includes rails 51a (guide members) vertically extending along axes S1 and S2 substantially parallel to each other. The rails 51a are fixed to the rail bases 51 (see FIG. 3A) using fastener members such as screws or the like.

As shown in FIG. 3B, the linear motion mechanism 50 further includes slider blocks (sliders) slidably arranged with respect to the rails 51a. The rails 51a and the slider blocks 52 make up a so-called “linear guide”. In the following description, the rails 51a and the slider blocks 52 making sliding contact with each other will be referred to as “sliding contact unit”.

The slider blocks 52 are connected to a lift flange base 15a, i.e., a base frame, of the lift flange unit 15 and are unified with the lift flange unit 15.

The linear motion mechanism 50 is provided with a ball screw unit 53 including a ball nut connected to the lift flange base 15a. The ball screw unit 53 further includes a ball screw and a motor. The ball screw unit 53 converts the rotating motion of the motor to the linear motion along an axis 53 substantially parallel to the vertical direction.

The linear motion mechanism 50 stated above enables the lift flange unit 15 to move up and down along the vertical direction.

As shown in FIG. 3B, the lift flange unit 15 has a hollow structure. By providing a pipe 15b in the hollow portion of the lift flange unit 15, it becomes possible to easily arrange cables or the like.

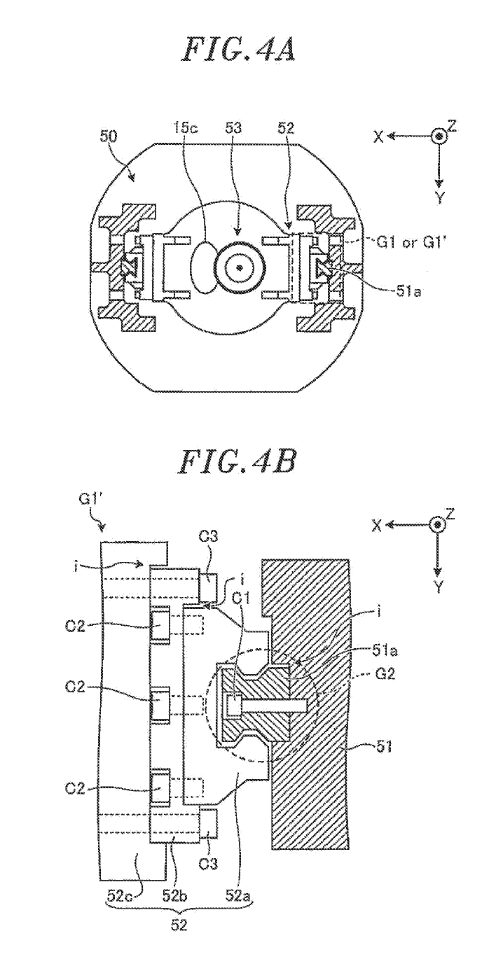

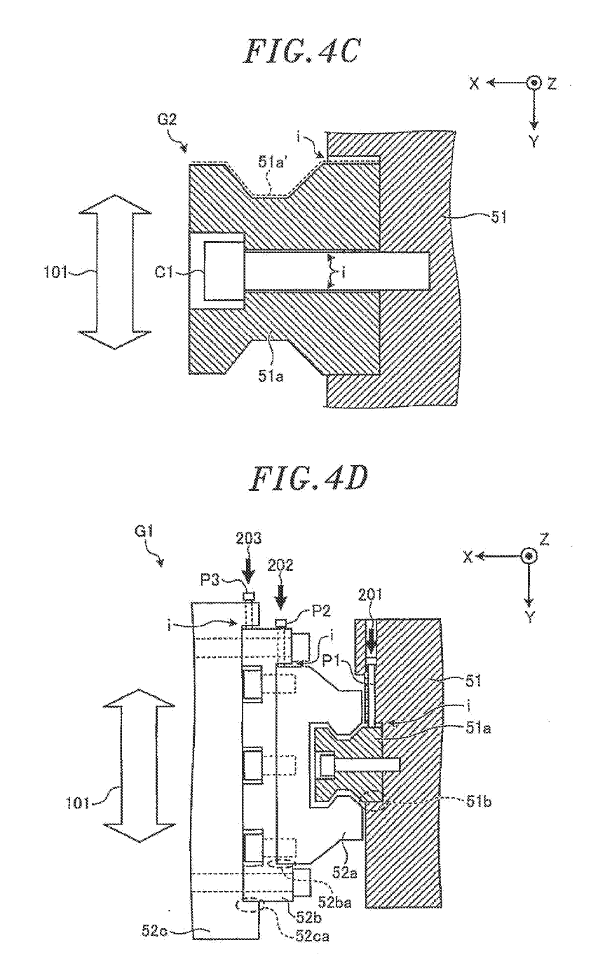

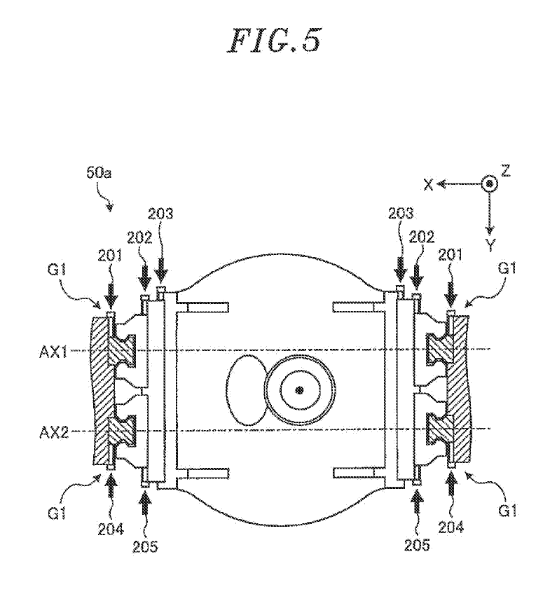

Next, the installation structure of individual members making up the linear motion mechanism 50 according to the first embodiment will be described with reference to FIGS. 4A through 4D. FIG. 4A is a section view taken along line 4A-4A in FIG. 3B. The contour line shown FIG. 4A schematically indicates the inner circumferential surface of the housing 11.

FIG. 4B is an enlarged view showing a conventional sliding contact unit G1′. FIG. 4C is an enlarged view of the region designated by G2 in FIG. 4B. FIG. 4D is an enlarged view showing a sliding contact unit 91 according to a first embodiment.

As shown in FIG. 4A, the linear motion mechanism 50 includes a sliding contact unit G1. In the following description, for the sake of convenience in description, the conventional sliding contact unit will be designated by reference symbol “G1′”.

Referring to FIG. 4A, an opening 15c through which the pipe 15b passes is formed adjacent to the ball screw unit 53.

Description will now be on the conventional sliding contact unit G1′. In the conventional sliding contact unit G1′ shown in FIG. 4B, the respective members making up the linear motion mechanism 50 are fastened only in a specified fastening direction by virtue of fastener members such as screws or the like. In the following description, the fastener members are “screws”. For the sake of convenience in illustration, the thread grooves of “male threads” and “female threads” are not shown in the drawings. With a view to distinguish the fastener members from “set screws” as pressing members, the “screws” as the fastener members will be referred to as “fastener screws”.

For example, as shown in FIG. 4B, the rail 51a is fastened to the rail base 51 by a fastener screw C1 at the positive side of the X-axis. A first block 52a, a second block 52b and a third block 52c of the slider block 52 are fastened by fastener screws C2 and C3 at the positive and negative sides of the X-axis.

The specified fastening direction along the X-axis is selected so as to enable the slider block 52 to slide smoothly while reliably pressing the rail 51a inherently susceptible to warp.

When fastening the respective members to one another, it is sometimes the case that gaps are generated between the fastened members due to the dimensional error or deviation of the respective members. For example as shown in FIG. 4B, gaps i may be generated between the rail 51a and the rail base 51, between the first block 52a and the second block 52b, and between the second block 52b and the third block 52c. As shown in FIG. 4C, a gap i may be generated between the rail 51a and the fastener screw C1.

Now, it assumed that the extendible arm unit described in respect of FIG. 1 performs an extending operation. At this time, a load such as a moment load acting in the directions indicated by a double-head arrow 101 is applied to the region G2 in FIG. 4C by way of the lift flange unit 15 (see FIG. 3A) arranged in the central portion of the flange portion 12. The load thus applied grows larger as the extendible arm unit extends.

For example, if a gap i is generated as shown in FIG. 4C, the rail 51a is likely to slide within the extent of the gap I by the load applied in the direction of the double head arrow 101. Thus the rail 51a may get out of alignment (see the rail 51a′ indicated by a broken line in FIG. 4C). In other words, the rail 51a and the rail base 51 are displaced relative to each other, thereby generating looseness. This may possibly reduce the operation accuracy of the linear motion mechanism 50.

In the linear motion mechanism 50 according to the first embodiment, as shown in FIG. 4D, the constituent members of the sliding contact unit G1 fastened by the fastener members in the specified fastening direction substantially orthogonal to the axial direction of the guide members are pressed by a pressing member in the orthogonal direction substantially orthogonal to both the axial direction and the fastening direction.

More specifically, as shown in FIG. 4D, the constituent members of the sliding contact unit G1 are pressed by a pressing member such as a set screw or the like in the direction (Y-axis direction) substantially orthogonal to both the axial direction (Z-axis direction) of the rail 51a and the specified fastening direction (X-axis direction) substantially orthogonal to the axial direction.

For example, the rail 51a is pressed by a set screw P1 from the negative side of the Y-axis direction toward the positive side thereof (see an arrow 201 in FIG. 4D). At this time, the end surface of the rail 51a is pressed against the sidewall 51b of a recess of the rail base 51 by the set screw P1. That is to say, the sidewall 51b becomes a reference surface (pressed surface) for positioning the rail 51a.

The first block 52a is pressed by a set screw P2 from the negative side of the Y-axis direction toward the positive side thereof (see an arrow 202 in FIG. 4D). At this time, the end surface of the first block 52a is pressed against the sidewall 52ba of a recess of the second block 52b by the set screw P2. That is to say, the sidewall 52ba becomes a reference surface for positioning the first block 52a.

The second block 52b is pressed by a set screw P3 from the negative side of the Y-axis direction toward the positive side thereof (see an arrow 203 in FIG. 4D. At this time, the end surface of the second block 52b is pressed against the sidewall 52ca of a recess of the third block 52c by the set screw P3. That is to say, the sidewall 52ca becomes a reference surface for positioning the second block 52b.

As a consequence, the fastening members for fastening the constituent members of the sliding contact unit G1 can prevent the constituent members from being slid by the load such as a moment indicated by the double head arrow 101 in FIG. 4D. This makes it possible to accurately perform a task positioning the constituent members of the sliding contact unit G1. In other words, it is possible to accurately operate the linear motion mechanism 50 and the robot 1 provided with the linear motion mechanism 50.

While the set screws P1, P2 and P3 shown in FIG. 4D have screw heads, the shape of the set screws P1, P2 and P3 is not limited thereto. It may be possible to use a full-thread screw having no screw head, e.g., a so-called “socket set screw”.

As described above, the linear motion mechanism according to the first embodiment and the robot provided with the linear motion mechanism include guide members attached to base portions and sliders arranged to slide along the axial direction of the guide members. The guide members are fastened to the base portions by the fastening members in the specified fastening direction substantially orthogonal to the axial direction. The guide members are pressed by the pressing members in the orthogonal direction substantially orthogonal to both the axial direction and the fastening direction.

Accordingly, the linear motion mechanism according to the first embodiment and the robot provided with the linear motion mechanism can operate with increased accuracy.

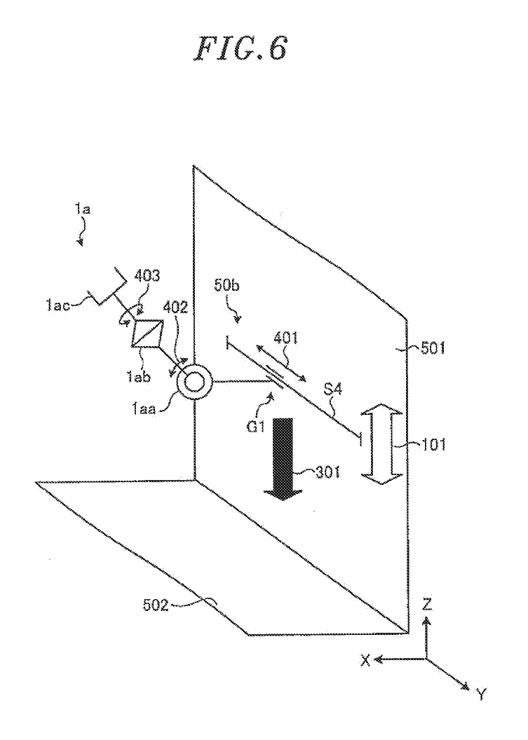

While one pair of guide members arranged in an opposing relationship is employed in the first embodiment described above, it may be possible to employ two pairs of guide members. Now, a second embodiment in which two pairs of guide members are employed will be described with respect to FIG. 5.

### Second Embodiment

FIG. 5 is a schematic diagram showing major parts of a linear motion mechanism 50a according to a second embodiment. FIG. 5 corresponds to FIG. 4A and remains substantially the same as FIG. 4A except that the guide members are provided in two pairs. No description will be made on the points common to FIGS. 5 and 4A.

While the fastener screws are not shown in FIG. 5, the specified fastening direction of the fastener screws extends along the X-axis. The gaps i shown in FIGS. 4B and 4D are not illustrated in FIG. 5. The linear motion mechanism 50a according to the second embodiment is provided in a robot having the same configuration as the robot 1 according to the first embodiment.

As shown in FIG. 5, the linear motion mechanism 50a according to the second embodiment includes two pairs of guide members (two pairs of sliding contact units G1 including the guide members) arranged along the X-axis direction in a mutually opposing relationship.

In a pair of sliding contact units G1 arranged along an axis AX1 substantially parallel to the X-axis in a mutually opposing relationship, the portions indicated by arrows 201, 202 and 203 are pressed by set screws from the negative side of the Y-axis toward the positive side thereof.

In a pair of sliding contact units G1 arranged along an axis AX2 substantially parallel to the X-axis in a mutually opposing relationship, the portions indicated by arrows 204 and 205 are pressed by set screws from the positive side of the Y-axis toward the negative site thereof.

The pressing direction of the set screws is not particularly limited insofar as the pressing direction is a direction (Y-axis direction) substantially orthogonal to both the axial direction of the guide members (Z-axis direction) and the specified fastening direction (X-axis direction).

While two pairs of sliding contact units G1 are arranged side by side along the X-axis in FIG. 5, the present disclosure is not limited thereto.

For example, one pair of sliding contact units G1 may be arranged in a mutually opposing relationship along the X-axis as shown in FIG. 5, while the other pair of sliding contact units G1 may be arranged in a mutually opposing relationship along the Y-axis. in this case, the sliding contact units G1 arranged in a mutually opposing relationship along the Y-axis are pressed by set screws in the X-axis direction.

As described above, the linear motion mechanism according to the second embodiment and the robot provided with the linear motion mechanism include two pairs of guide members opposingly arranged on base portions and two pairs of sliders arranged to slide along the axial direction of the guide members. The guide members are fastened to the base portions by the fastening members in the specified fastening direction substantially orthogonal to the axial direction. The guide members are pressed by the pressing members in the orthogonal direction substantially orthogonal to both the axial direction and the fastening direction.

Accordingly, the linear motion mechanism according to the second embodiment and the robot provided with the linear motion mechanism can operate with increased stability and accuracy.

While at least one pair of guide members arranged in a mutually opposing relationship forms a set in the respective embodiments described above, the guide members may not be the combination of pairs. For example, if the horizontal cross section of the housing of the body unit is substantially circular, three guide members may form a set and may be arranged on the inner circumferential surface of the housing at an interval of 120 degrees.

While the guide members of the linear motion mechanism extend along the vertical direction in the respective embodiments described above, the present disclosure is not limited thereto. For example, the guide members may extend in the horizontal direction. Now, a third embodiment in which the guide members of the linear motion mechanism extend in the horizontal direction will be described with respect to FIGS. 4D and 6.

### Third Embodiment

FIG. 6 is an explanatory view showing a linear motion mechanism 50b according to a third embodiment. For the sake of convenience in description, FIG. 6 illustrates an example in which the robot 1a provided with the linear motion mechanism 50b is formed of a three axes robot. However, the number of axes and the rotating direction of joints are not particularly limited as long as the robot 1a is provided. with the linear motion mechanism. 50b. In FIG. 6, the robot 1a is illustrated in a simplified manner.

As shown in FIG. 6, the robot 1a according to the third embodiment includes a linear motion mechanism 50b, a first joint portion 1aa, a second joint portion 1ab and an end effector 1ac. In FIG. 6, arms are indicated by the solid lines interconnecting the linear motion mechanism 50b, the first joint portion 1aa, the second joint portion 1ab, and the end effector 1ac.

The linear motion mechanism 50b includes a horizontal guide 54 horizontally arranged on a wall surface 501 as a base portion and a sliding contact unit G1 having the same configuration as those of the respective embodiments described above. The linear motion mechanism 50b linearly moves all the arms along the horizontal guide S4 in the direction indicated by a double head arrow 401. The first joint portion 1aa is a joint, portion rotating in the direction indicated by a double head arrow 402. The second joint portion 1ab is a joint portion swinging in the direction indicated by a double head arrow 403.

For example, if the first joint portion 1aa is rotated to thereby extend all the arms or if the sliding contact unit G1 reaches the end portion of the horizontal guide S4, a load such as a moment indicated by a double head arrow 101 is applied to the linear motion mechanism 50b.

Moreover, the gravity indicated by an arrow 301 acts on the robot 1a including the linear motion mechanism 50b.

For the sake of convenience in description, FIG. 4D is regarded as an enlarged view of the sliding contact unit G1 which is seen at the positive side of the Y-axis in FIG. 6. Therefore, the rectangular coordinate axes, XYZ, indicated in FIG. 4D are not referred to. The lower side along the drawing sheet surface in FIG. 4D is regarded as a vertical lower side.

As shown in FIG. 4D, the sliding contact unit G1 of the linear motion mechanism 50b according to the third embodiment can be pressed by the pressing members in the orthogonal direction substantially orthogonal to both the axial direction of the rail 51a and the specified fastening direction of the sliding contact unit G1.

At this time, the gravity acts on the sliding contact unit G1 as shown in FIG. 6. if the pressing force applied by the gravity is used in combination, it is only necessary that the sliding contact unit G1 is pressed by the set screws P1, P2 and P3 from the vertical upper side toward the vertical lower site (from the upper site toward the lower side of the drawing he in FIG. 4D). This does not exclude the possibility that the pressing is performed in the opposite direction, namely from the vertical lower side toward the vertical upper side.

Needless to say, the installation method described hereinabove can be used in the event that the horizontal guide S4 shown in FIG. 6 is arranged on the floor surface 502 as a base portion rather than the wall surface 501.

As described above, the linear motion mechanism according to the third embodiment and the robot provided with the linear motion mechanism include a guide member horizontally arranged on a base portion and a slider arranged to slide along the axial direction of the guide member. The guide member is fastened to the base portion by the fastening members in the specified fastening direction substantially orthogonal to the axial direction. The guide member is pressed by the pressing members in the orthogonal direction substantially orthogonal to both the axial direction and the fastening direction.

Accordingly, the linear motion mechanism according to the third embodiment and the robot provided with the linear motion mechanism can operate with increased accuracy even if the guide member is arranged on the wall surface or the like.

While the fastening members and the pressing members are screws in the respective embodiments described above, the present disclosure is not limited thereto. For example, the fastening members and the pressing members may be rivets or the combination of screws and rivets.

While the end surfaces of the guide member and the slider are pressed by the pressing members in the respective embodiments described above, the present disclosure is not limited thereto. For example, the fastening members may be directly pressed by the pressing members in the orthogonal direction substantially orthogonal to the fastening direction.

The structure for bringing the slider into sliding contact with the guide member is not particularly limited. For example, a rolling body such as a bearing or the like and a hydraulic pressure may be used.

While the robot is a substrate transfer robot in the respective embodiments described above, the use of the robot does not matter as long as the robot operates along the guide member as a linear motion guide.

Other effects and other modified examples can be readily derived by those skilled in the art. For that reason, the broad aspect of the present disclosure is not limited to the specific disclosure and the representative embodiment shown and described above. Accordingly, the present disclosure can be modified in many different forms without departing from the scope defined by the appended claims and the equivalents thereof.

What is claimed is:

1. A linear motion mechanism, comprising:
a base portion;
a guide member attached to the base portion; and
a slider provided to slide along an axial direction of the guide member,
wherein the guide member is fastened to the base portion by a guide fastening member in a specified fastening direction substantially orthogonal to the axial direction, and is pressed by a guide pressing member in an orthogonal direction substantially orthogonal to both the axial direction and the fastening direction.

2. The mechanism of claim 1, wherein the slider includes a plurality of members fastened together by a slider fastening member in the fastening direction, the slider being pressed by a slider pressing member in the orthogonal direction.

3. The mechanism of claim 1, wherein the guide member includes a plurality of members fastened together by the guide fastening member in the fastening direction, the guide member being pressed by the guide pressing member in the orthogonal direction.

4. The mechanism of claim 2, wherein the guide pressing member and the slider pressing member are configured to press one of the members fastened together by the guide fastening member and the slider fastening member toward a pressed surface formed in the other member.

5. The mechanism of claim 1, wherein the guide member is provided to extend along a vertical direction.

6. The mechanism of claim 1, wherein the guide member is provided so extend along a horizontal direction.

7. The mechanism of claim 1, wherein the base portion is a wall surface.

8. A robot comprising the linear motion mechanism of claim 1.

9. The robot of claim 8, further comprising a housing formed into a substantially tubular shape, the guide member including at least one pair of guide members arranged on an inner circumferential surface of the housing serving as the base portion.

10. The robot of claim 9, wherein the guide member includes two pairs of guide members opposingly arranged on the inner circumferential surface of the housing.
